(19) United States
(12) Patent Application Publication
(10) Pub. No.: US 2025/0037071 A1
(43) Pub. Date: Jan. 30, 2025

(54) SYSTEMS AND METHODS FOR DYNAMICALLY MODIFYING A VIRTUAL WAREHOUSE

(71) Applicant: Capital One Services, LLC, McLean, VA (US)

(72) Inventors: John PHINIZY, Midlothian, VA (US); Chih-Hsiang CHOW, Coppell, TX (US)

(73) Assignee: Capital One Services, LLC, McLean, VA (US)

(21) Appl. No.: 18/361,091

(22) Filed: Jul. 28, 2023

(51) Int. Cl. G06Q 10/087

(52) U.S. Cl. CPC G06Q 10/087

(57) ABSTRACT

A method for dynamically modifying a virtual warehouse is disclosed. The method includes determining a first feature of interest of a virtual object of the virtual warehouse based on a first passive user interaction with the virtual object, generating a first search query based on the determined first feature of interest, identifying one or more first search results that corresponds to the first search query, the one or more first search results including at least one object with at least one feature, modifying the virtual warehouse based on the one or more first search results, and causing a user interface to output the modified virtual warehouse.

### TECHNICAL FIELD

Various embodiments of this disclosure relate generally to dynamically modifying a virtual warehouse and, more particularly, to systems and methods for determining one or more features of interest of a virtual object of the virtual warehouse based on one or more passive user interactions with the virtual object.

### BACKGROUND

Conventional methods of vehicle shopping, e.g., in person at a merchant and/or online, often involve enormous amount of pictures, information, and options provided to a potential buyer. For example, even if a potential buyer knows they want a sedan, there are still hundreds of variations of sedans available to choose from. The hundreds of vehicles in a merchant lot or seemingly endless pictures on a dealer's website may be overwhelming for potential buyers. The visual overload—common for potential buyers in these conditions—often leads to chilling potential buyers' interest in continuing shopping and/or completing the sale.

This disclosure is directed to addressing the above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for dynamically modifying a virtual warehouse.

In one aspect, a method for dynamically modifying a virtual warehouse is disclosed. The method may include determining a first feature of interest of a virtual object of the virtual warehouse based on a first passive user interaction with the virtual object; generating a first search query based on the determined first feature of interest; identifying one or more first search results that corresponds to the first search query, the one or more first search results including a plurality of objects, the plurality of objects including a plurality of features; modifying the virtual warehouse based on the one or more first search results; and causing a user interface to output the modified virtual warehouse.

In another aspect, a system is disclosed. The system may include at least one memory storing instructions; and at least one processor executing the instructions to perform operations for dynamically modifying a virtual warehouse. The operations may include: determining a first feature of interest of a virtual object of the virtual warehouse based on a first passive user interaction with the virtual object; generating a first search query based on the determined first feature of interest; identifying one or more first search results that corresponds to the first search query, the one or more first search results including a plurality of objects, the plurality of objects including a plurality of features; modifying the virtual warehouse based on the one or more first search results; and causing a user interface to output the modified virtual warehouse.

In another aspect, a method for dynamically modifying a virtual warehouse is disclosed. The method may include determining a first feature of interest of a virtual object of the virtual warehouse by: determining a potential interest in a feature based on a first passive user interaction with the feature, the first passive user interaction including one or more of a user gaze fixation time, a user gaze fixation value, a user proximity time, a user proximity value, a user interaction time, or a user interaction value; gauging a correctness of the potential interest in the feature of interest by: determining, to use as a control feature, a potential interest in a counterexample feature of the feature, based on a second passive user interaction with the counterexample feature, the second passive user interaction including one or more of a further user gaze fixation time, a further user gaze fixation value, a further user proximity time, a further user proximity value, a further user interaction time, or a further user interaction value; and comparing the potential interest in the feature with the potential interest in the counterexample feature; generating a first search query based on the determined first feature of interest; identifying one or more first search results that corresponds to the first search query, the one or more first search results including a plurality of objects, the plurality of objects including a plurality of features; modifying the virtual warehouse based on the one or more first search results; and causing a user interface to output the modified virtual warehouse.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment for dynamically modifying a virtual warehouse, according to one or more embodiments.

FIGS. 2A-2B depict exemplary methods for dynamically modifying a virtual warehouse, according to one or more embodiments.

FIGS. 3A-3D depict exemplary visual representations of dynamic modifications of a virtual warehouse, according to one or more embodiments.

FIGS. 4A-4C depict further exemplary visual representations of dynamic modifications of a virtual warehouse, according to one or more embodiments.

FIG. 5 depicts an example machine learning training flow chart, according to some embodiments of the disclosure.

FIG. 6 depicts a simplified functional block diagram of a computer, according to one or more embodiments.

### DETAILED DESCRIPTION OF EMBODIMENTS

Reference to any particular activity is provided in this disclosure only for convenience and not intended to limit the disclosure. The disclosure may be understood with reference to the following description and the appended drawings, wherein like elements are referred to with the same reference numerals.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. The term “or” is used disjunctively, such that “at least one of A or B” includes, (A), (B), (A and A), (A and B), etc. Relative terms, such as, “substantially” and “generally,” are used to indicate a possible variation of ±10% of a stated or understood value.

It will also be understood that, although the terms first, second, third, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

As used herein, a “machine learning model” generally encompasses instructions, data, and/or a model configured to receive input, and apply one or more of a weight, bias, classification, or analysis on the input to generate an output. The output may include, for example, a classification of the input, an analysis based on the input, a design, process, prediction, or recommendation associated with the input, or any other suitable type of output. A machine learning model is generally trained using training data, e.g., experiential data and/or samples of input data, which are fed into the model in order to establish, tune, or modify one or more aspects of the model, e.g., the weights, biases, criteria for forming classifications or clusters, or the like. Aspects of a machine learning model may operate on an input linearly, in parallel, via a network (e.g., a neural network), or via any suitable configuration.

As used herein, the term “user” or the like may refer to a person accessing a virtual space, using virtual reality (VR) glasses, headset, etc. As used herein, terms like “provider,” “merchant,” “vendor,” or the like generally encompass an entity or person involved in providing, selling, and/or renting items to persons such as a seller, dealer, renter, merchant, vendor, or the like, as well as an agent or intermediary of such an entity or person. As used herein, the term “virtual warehouse” may refer to a virtual representation of a merchant lot and/or a merchant stock. As used herein, the term “stock” refers to real-world items that may be virtually represented via a virtual space. For example, a vehicle merchant may have a real-world stock of vehicles that may have virtual representations in a virtual space. As used herein, the term “inventory” refers to the virtual representation of one or more stock items in a virtual warehouse. For example, inventory displayed in a virtual space may be virtual representations of the vehicle merchant's stock of vehicles.

The execution of the machine learning model may include deployment of one or more machine learning techniques, such as linear regression, logistical regression, random forest, gradient boosted machine (GBM), deep learning, and/or a deep neural network. Supervised and/or unsupervised training may be employed. For example, supervised learning may include providing training data and labels corresponding to the training data, e.g., as ground truth. Unsupervised approaches may include clustering, classification or the like. K-means clustering or K-Nearest Neighbors may also be used, which may be supervised or unsupervised. Combinations of K-Nearest Neighbors and an unsupervised cluster technique may also be used. Any suitable type of training may be used, e.g., stochastic, gradient boosted, random seeded, recursive, epoch or batch-based, etc.

According to an example of the disclosed subject matter, a user may shop via a virtual reality (VR) system, which they use to access a virtual warehouse. A system hosting the virtual warehouse may be configured to modify a virtual warehouse based on passive user interaction. The user may access the virtual warehouse and the hosting system may, based on one or more passive interactions of the user, e.g., via the VR system with one or more virtual objects, predict which features of the virtual warehouse and/or one or more virtual objects the user may be interested in. One or more features and/or counterexamples to the one or more features may be determined and/or presented to a user, e.g., to determine one or more features indicative of a user-specific ideal virtual object.

In an exemplary use case, a user may be shopping for a new vehicle. The user may use a VR headset to access a virtual warehouse. The virtual warehouse may be a virtual vehicle merchant with an inventory of virtual vehicles. The user may passively interact with the virtual warehouse and/or the virtual vehicles via an avatar. For example, the avatar may look at and/or stand near a first vehicle more than a second vehicle, which may indicate that the first vehicle has at least one feature of interest for the user. Depending on the determined at least one feature of interest, a search query may be generated for vehicles in the dealer's stock including that feature of interest and/or the virtual warehouse may be modified to include a higher proportion of vehicles with that feature of interest.

The avatar may continue passively interacting with the virtual warehouse and/or the virtual vehicles, and further features of interest may be determined. For example, a first feature of interest, a second feature of interest, and/or a third feature of interest may be determined. The first feature of interest, the second feature of interest, and/or the third feature of interest may be compared to determine the relative weight of each feature of interest. If the features of interest are ranked as the second feature of interest, the first feature of interest, then the third feature of interest, a further search query may be generated to prioritize the second feature of interest first, the first feature of interest second, and the third feature of interest third.

The virtual warehouse may be modified to include a counterexample. Providing a counterexample may be advantageous in that it may account for errors, e.g., system glitches, or changing user preferences. The counterexample may additionally or alternatively be used to determine the correctness of a previously determined feature of interest. If a user shows interest in the counterexample, e.g., via passive interaction, the virtual warehouse may be modified to include a higher proportion of vehicles with the counterexample feature, and/or may not be modified to include a higher proportion of vehicles with the feature of interest. If a user does not show interest in the counterexample, e.g., via a lack of passive interaction, the virtual warehouse may consider the feature of interest validated. For example, if the user largely ignores the counterexample, the system may determine that the user is not interested in the counterexample, the feature of interest is confirmed, etc.

While the examples above involve generating a virtual warehouse based on passive user interaction with virtual vehicles, it should be understood that techniques according to this disclosure may be adapted to any suitable virtual representation (e.g., animals, art, appliances, etc.). It should also be understood that the examples above are illustrative only. The techniques and technologies of this disclosure may be adapted to any suitable activity. Presented below are various systems and methods of generating a dynamically modifying a virtual warehouse.

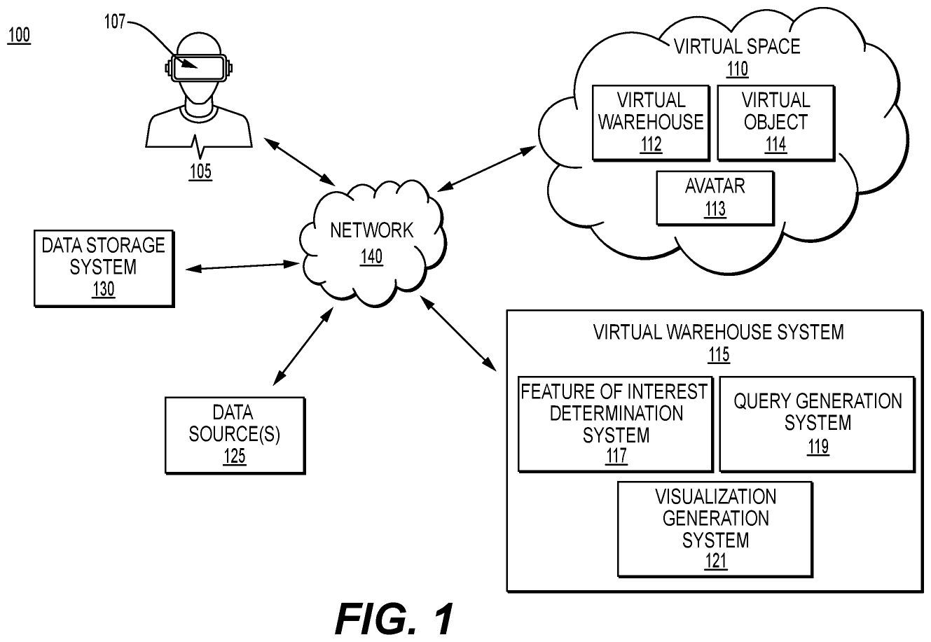

FIG. 1 depicts an exemplary environment for dynamically modifying a virtual warehouse, according to one or more embodiments. Environment 100 of FIG. 1 depicts a user 105, a virtual space 110, a virtual warehouse system 115, one or more data sources 125, a data storage system 130, and a network 140. User 105 may use a user device 107 (e.g., a virtual reality (VR) headset) configured to access one or more other aspects of environment 100. For example, virtual space 110 may be accessible using other aspects of environment 100, e.g., user device 107. User device 107 may include one or more sensors of various types that may be configured to capture data, e.g., interaction data. The data captured by the one or more sensors of user device 107 may be transmitted to virtual space 110, virtual warehouse system 115, etc.

In some embodiments, virtual space 110 may be configured to connect aspects of environment 100 to a virtual world and/or a virtual reality. A virtual space, virtual world, or virtual reality may refer to a computer-simulated environment that may present perceptual stimuli, e.g., a virtual warehouse 112 and/or a virtual object 114, to a user and/or enable users to manipulate the elements of the computer-simulated environment. Virtual space 110 may be hosted by an application, e.g., a vehicle shopping application, a clothing shopping application, a grocery shopping application, etc. Virtual space 110 may be configured to display at least virtual warehouse 112 and/or a virtual object 114. Virtual warehouse 112 and/or virtual object 114 may be virtual representations of a room, object, or event. As discussed in further detail below, in some embodiments, objects displayed as virtual warehouse 112 and/or virtual object 114 may correspond to a real-world stock. For example, virtual warehouse 112 may be a virtual showroom and virtual object 114 may be a vehicle displayed in virtual warehouse 112. In some embodiments, a user, e.g., user 102, may be able to interact with one or more aspects of virtual space 110 via an avatar. For example, the avatar of user 102 (hereinafter “avatar”) 113 may be able to interact with one or more aspects of virtual object 114.

Virtual warehouse system 115 may include a feature of interest determination system (hereinafter “feature ID system”) 117, a query system 119, and/or a visualization generation system 121. Feature ID system 117 may be configured to determine one or more features of interest associated with a user. In some embodiments, feature ID system 117 may be configured to determine the one or more features of interest based on one or more interactions of user 102 with a feature of virtual warehouse 112 and/or of virtual object 114. For example, one or more features for a vehicle may include style, make, model, year, mileage, miles per gallon, battery power, color, number of doors, presence of a sunroof or moon roof, tire size, number of tires, design, etc. If user 102 repeatedly stands near sedans for extended amounts of time, feature ID system 117 may determine that the style “sedan” is a feature of interest associated with user 102.

Feature ID system 117 may be configured to determine the one or more feature of interest. Feature ID system 117 may obtain feature of interest data from any suitable aspect of environment 100, e.g., user device 107, virtual space 110, one or more data sources 125, data storage system 130, etc. Feature ID system 117 may determine feature of interest data via monitoring eyeball movements, one or more algorithms, other VR controls, etc. For example, feature ID system 117 may determine feature of interest data via the one or more sensors of user device 107.

Feature of interest data may include available feature data (e.g., what features of a vehicle are available in a stock, what features of a vehicle are available outside of a stock, etc.), interaction data (e.g., amount, length, type, etc. of user and/or avatar 113 interaction with a feature), etc. The interaction data may additionally or alternatively include user gaze fixation time (e.g., how long avatar 113 looks at an item or aspect of virtual warehouse 112 and/or virtual object 114), user gaze fixation value (e.g., how many times avatar 113 looks at an item or aspect of virtual warehouse 112 and/or virtual object 114), user proximity time (e.g., how long avatar 113 spends near at an item or aspect of virtual warehouse 112 and/or virtual object 114), user proximity value (e.g., how many times avatar 113 is near at an item or aspect of virtual warehouse 112 and/or virtual object 114), user interaction time (e.g., how long avatar 113 interacts with an item or aspect of virtual warehouse 112 and/or virtual object 114), user interaction value (e.g., how many times avatar 113 interacts with an item or aspect of virtual warehouse 112 and/or virtual object 114), etc. For example, if avatar 113 repeatedly stands near motorcycles for extended amounts of time, the motorcycles may be determined to be a feature of interest to the user 102.

Feature ID system 117 may include one or more algorithms, models, or the like for parsing and/or analyzing feature of interest data to determine one or more features of interest for a user 102. An exemplary method for determining the one or more features of interest is described in further detail below. Feature ID system 117 may output and/or transmit the determined one or more features of interest to any suitable aspect of environment 100, e.g., query generation system 119, visualization generation system 121, one or more data sources 125, data storage system 130, etc.

As discussed in further detail below, feature ID system 117 may one or more of generate, store, train, and/or use a machine learning model configured to determine one or more features of interest. Feature ID system 117 may include a machine learning model and/or instructions associated with the machine learning model, e.g., instructions for generating a machine learning model, training the machine learning model, using the machine learning model etc. Feature ID system 117 may include instructions for retrieving passive user interaction data, active user interaction data, adjusting one or more user preference data, e.g., based on the output of the machine learning model, and/or operating the GUI associated with user device 107 to output one or more user preference data, e.g., as adjusted based on the machine learning model. Feature ID system 117 may include training data, e.g., training passive user interaction data, training active user interaction data, training virtual object data, and training virtual warehouse data, training outcome data (e.g., vehicle purchase made by user 102), and may include ground truth, e.g., feature of interest data. The machine learning model of feature ID system 117 may be trained to determine subconscious desires of user 102 based on at least the determined passive user interaction(s) and/or outcome data. For example, while user 102 may actively request an SUV, if they passively interact with sedans more than SUVs, the techniques described herein may be configured to determine that user 102 would prefer a sedan to an SUV.

In some embodiments, a system or device other than feature ID system 117 is used to generate and/or train the machine learning model. For example, such a system may include instructions for generating the machine learning model, the training data and ground truth, and/or instructions for training the machine learning model. A resulting trained machine learning model may then be provided to feature ID system 117.

Generally, a machine learning model includes a set of variables, e.g., nodes, neurons, filters, etc., that are tuned, e.g., weighted or biased, to different values via the application of training data. In supervised learning, e.g., where a ground truth is known for the training data provided, training may proceed by feeding a sample of training data into a model with variables set at initialized values, e.g., at random, based on Gaussian noise, a pre-trained model, or the like. The output may be compared with the ground truth to determine an error, which may then be back-propagated through the model to adjust the values of the variable.

Training may be conducted in any suitable manner, e.g., in batches, and may include any suitable training methodology, e.g., stochastic or non-stochastic gradient descent, gradient boosting, random forest, etc. In some embodiments, a portion of the training data may be withheld during training and/or used to validate the trained machine learning model, e.g., compare the output of the trained model with the ground truth for that portion of the training data to evaluate an accuracy of the trained model. The training of the machine learning model may be configured to cause the machine-learning model to learn associations between the training data and the ground truth data, such that the trained machine learning model is configured to determine an output one or more user preferences in response to the input passive user interaction data based on the learned associations.

In various embodiments, the variables of a machine learning model may be interrelated in any suitable arrangement in order to generate the output. For example, the machine-learning model may include one or more convolutional neural network (CNN) configured to identify features in the passive user interaction data, and may include further architecture, e.g., a connected layer, neural network, etc., configured to determine a relationship between the identified features in order to determine one or more user preferences.

In some instances, different samples of training data and/or input data may not be independent. Thus, in some embodiments, the machine learning model may be configured to account for and/or determine relationships between multiple samples. For example, in some embodiments, the machine learning model of feature ID system 117 may include a Recurrent Neural Network (RNN). Generally, RNNs are a class of feed-forward neural networks that may be well adapted to processing a sequence of inputs. In some embodiments, the machine learning model may include a Long Short Term Memory (LSTM) model and/or Sequence to Sequence (Seq2Seq) model.

In some embodiments, one or more aspects of virtual warehouse system 115, e.g., query generation system 119, visualization generation system 121, etc., may be configured to generate and/or modify a virtual representation, e.g., virtual warehouse 112 and/or virtual object 114, based on the determined one or more features of interest. An exemplary method for generating and/or modifying the virtual representation is described in further detail below.

Query generation system 119 may be configured to generate one or more search queries. Query generation system 119 may generate one or more search queries based on data obtained from any suitable aspect of environment 100, e.g., user device 107, virtual space 110, other aspects of virtual warehouse system 115, one or more data sources 125, and/or data storage system 130. Query generation system 119 may generate one or more search queries based on data including at least one of stock data, interaction data, feature of interest data (e.g., first feature of interest data, second feature of interest data, etc.), user preference data (e.g., weighted preferences between a first feature of interest and a second feature of interest, etc.), counterexample data, confirmation data, etc. For example, query generation system 119 may generate a search query based on stock data obtained from one or more data sources 125 and/or interaction data obtained from virtual space 110. Query generation system 119 may be configured to output the one or more search queries to any suitable aspect of environment 100, e.g., user device 107, virtual space 110, other aspects of virtual warehouse system 115, one or more data sources 125, data storage system 130, etc.

Query generation system 119 may be configured to generate one or more search queries based on one or more determined weights, e.g., relative weights of the one or more features of interest. In some embodiments, weights for each of the user gaze fixation time, the user gaze fixation value, the user proximity time, the user proximity value, the user interaction time, and/or the user interaction value may be determined. The weight for each data point may be based on the determined value relative to the data point, e.g., a greater gaze fixation time may be weighed less than a greater gaze fixation value. For example, a user gaze time of 34 seconds may be weighed less than a user gaze value of 17. In another example, a user gaze time of 2 minutes seconds may be weighed more than a user gaze value of 2. Any suitable method for setting and/or determining weights may be used.

Visualization generation system 121 may be configured to generate one or more virtual representations, e.g., virtual warehouse 112, virtual object 114, a counterexample, etc. Visualization generation system 121 may generate the one or more virtual representations based on data obtained from any suitable aspect of environment 100, e.g., user device 107, virtual space 110, other aspects of virtual warehouse system 115, the one or more one or more data sources 125, data storage system 130, etc. The data may include any of the data discussed herein, such as stock data, interaction data, feature of interest data, user preference data, counterexample data, confirmation data, etc. For example, visualization generation system 121 may be configured to generate one or more virtual representations based on one or more search queries.

In some techniques, the virtual representation of a virtual object 114 may be generated using a 3-dimensional (3D) rendering of the real-world stock item. For example, a truck that is capable of being virtually represented in virtual warehouse 112 may undergo virtual rendering so the various features of the vehicle may be represented. In some techniques, the 3D rendering may be parametric such that various features of the vehicle may be analyzed to be virtually modifiable. For example, a vehicle's chassis, number of doors, color, roof style (e.g., no roof or roof), etc. may be analyzed parametrically to allow modification of the various features.

Visualization generation system 121 may be configured to output and/or transmit one or more virtual representations to any suitable aspect of environment 100, e.g., user device 107, virtual space 110, other aspects of virtual warehouse system 115, the one or more one or more data sources 125, data storage system 130, etc.

The one or more data sources 125 may be configured to obtain inputs of data and/or metadata, e.g., data and/or metadata related to vehicle stock data. The one or more data sources 125 may receive inputs from other aspects of environment 100, e.g., user device 107, virtual space 110, virtual warehouse system 115, data storage system 130, etc., and/or from other sources, e.g., third party systems. For example, the one or more data sources 125 may obtain merchant stock data from a third party database or server that may be implementing the vehicle stock data. The one or more data sources 125 may communicate data to other aspects of environment 100, e.g., to user device 107, virtual space 110, virtual warehouse system 115, data storage system 130, etc.

One or more of the components in FIG. 1 may communicate with each other and/or other systems, e.g., across network 140. In some embodiments, network 140 may connect one or more components of environment 100 via a wired connection, e.g., a USB connection between user device 107 and virtual space 110. In some embodiments, network 140 may connect one or more aspects of environment 100 via an electronic network connection, for example a wide area network (WAN), a local area network (LAN), personal area network (PAN), or the like. In some embodiments, the electronic network connection includes the internet, and information and data provided between various systems occurs online. “Online” may mean connecting to or accessing source data or information from a location remote from other devices or networks coupled to the Internet. Alternatively, “online” may refer to connecting or accessing an electronic network (wired or wireless) via a mobile communications network or device. The Internet is a worldwide system of computer networks-a network of networks in which a party at one computer or other device connected to the network may obtain information from any other computer and communicate with parties of other computers or devices. The most widely used part of the Internet is the World Wide Web (often-abbreviated “WWW” or called “the Web”). A “website page,” a “portal,” or the like generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like. In any case, the connections within the environment 100 may be network, wired, any other suitable connection, or any combination thereof.

Although depicted as separate components in FIG. 1, it should be understood that a component or portion of a component in the environment 100 may, in some embodiments, be integrated with or incorporated into one or more other components. For example, virtual warehouse system 115 may be integrated in virtual space 110. In another example, virtual warehouse system 115 may further include a storage system, e.g., data storage system 130, which may store feature of interest data, metadata, virtual representations of a room, an event, or an object, and/or other relevant data. In some embodiments, operations or aspects of one or more of the components discussed above may be distributed amongst one or more other components. Any suitable arrangement and/or integration of the various systems and devices of the environment 100 may be used.

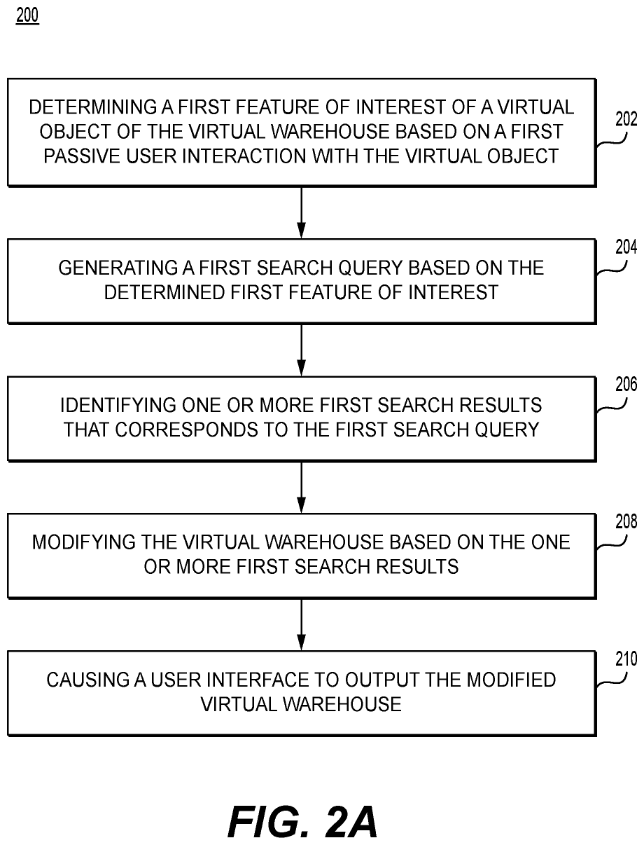

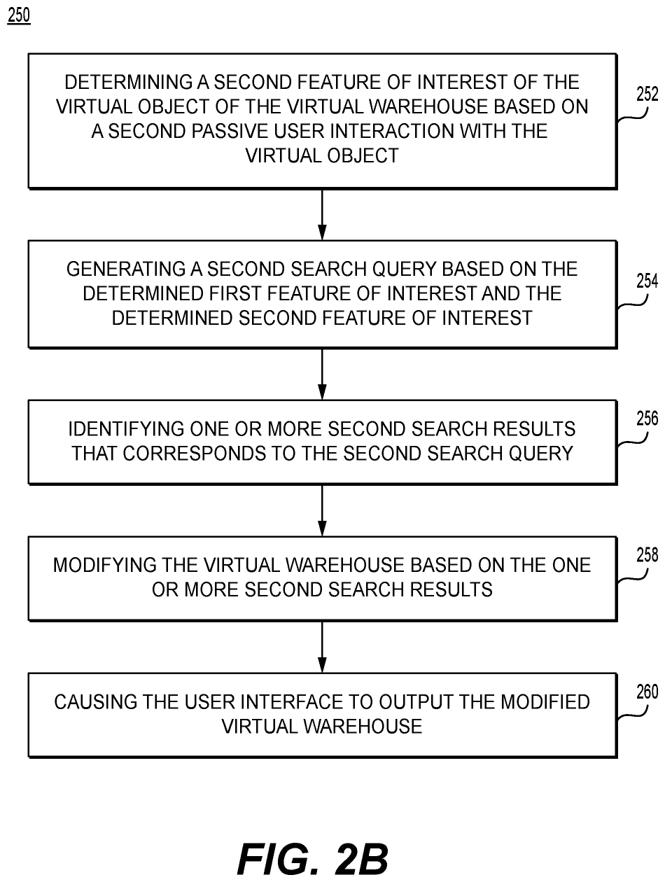

FIG. 2A depicts an exemplary method for dynamically modifying a virtual warehouse, according to one or more embodiments. In some techniques, a merchant may set up a virtual warehouse, e.g., virtual warehouse 112, to host virtual representations of one or more vehicles for sale, e.g., at least one virtual object 114. The merchant may have available in a database at least one virtual object 114, which may be 3D representations of the merchant's stock. When a user, e.g., user 102, operates a user device, e.g., user device 107, the merchant's virtual warehouse may be accessed, e.g., via an application. User 102 may provide active interaction information, e.g., desired vehicle make or model, price, mileage, etc. Virtual warehouse 112 may display the at least one virtual object 114 based on one or more of the active interaction information and/or an initial selection of the merchant's stock. The initial selection of a cross-section of the merchant's stock may be determined based on user-specific data (e.g., prior searches by user 102, prior purchases by user 102, etc.) and/or a randomized cross-section of the merchant's stock. A randomized cross-section of the merchant's stock may include a random selection of the broadest options available in a merchant's stock. For example, a randomized cross-section of the merchant's stock may include at least one sedan, at least one SUV, and at least one motorcycle. User 102 may actively and/or passively interact with the at least one virtual warehouse 112 and/or the at least one virtual object 114. The active and/or passive interactions may be measured, e.g., by featured ID system 117.

At step 202, a first feature of interest of a virtual object of a virtual warehouse may be determined, e.g., based on a user's potential interest in a feature. The first feature of interest may be determined using any suitable data, e.g., feature of interest data. As discussed herein, feature of interest data may include one or more of available feature data (e.g., what features of a vehicle are available in a stock, what features of a vehicle are available outside of a stock, etc.), interaction data (e.g., amount, length, type, etc. of user and/or avatar 113 interaction with a feature), etc.

In some embodiments, the first feature of interest may be determined by one or more of the user gaze fixation time, the user gaze fixation value, the user proximity time, the user proximity value, the user interaction time, and/or the user interaction value exceeding a predetermined threshold. The threshold may be user-specific. For example, a user may have a longer gaze fixation time overall, so exceeding the threshold for gaze fixation time may require a longer time. The threshold may be comparative. For example, if a user, e.g., via avatar 113, stands or moves near motorcycles a greater amount than avatar 113 stands near, moves near, and/or looks at sedans, SUVs, etc., method 200 may determine that a first feature of interest may be motorcycles. In another example, if avatar 113 looks at a motorcycle longer than they stand near an SUV, the feature of interest may be determined to be motorcycle.

In some embodiments, the first feature of interest may be determined via a trained machine learning model. For example, a trained machine learning model may be used to determine one or more user preferences based on passive user interaction data, e.g., the user gaze fixation time, the user gaze fixation value, the user proximity time, the user proximity value, the user interaction time, and/or the user interaction value. As discussed in greater detail herein, any suitable machine learning techniques may be used.

At step 204, a search query may be generated, e.g., a first search query. In some embodiments, the search query may be generated based on the first feature of interest determined in step 202. The search query may be generated via indexing, tokenizing, another suitable method, etc. For example, the stock may be indexed in a database by feature and the search query may be a query for the database. In another example, the database may be tokenized such that each feature is converted to a token, and querying is conducted by searching by a token value, e.g., a serial number corresponding to the feature. The search query may be executed to identify one or more search results, as described in further detail below (see step 206).

At step 206, one or more first search results corresponding to the first search query may be identified. The one or more first search results may include one or more stock items, e.g., real-world items that may be virtually represented via a virtual space. In some embodiments, each object of the one or more objects may include one or more features. As discussed herein, in some embodiments, the one or more features for vehicles may be one or more of style, make, model, year, mileage, miles per gallon, battery power, color, number of doors, presence of a sunroof or moon roof, tire size, number of tires, design, etc. For example, if the first search query is based on having two doors as the feature of interest, the one or more first search results may include vehicles available in a dealer's stock with two doors.

At step 208, the virtual warehouse may be modified. In some embodiments, the virtual warehouse may be modified based on the first search results. In some embodiments, the inventory of the virtual warehouse, e.g., one or more virtual objects, may be modified to include a higher proportion of objects having the determined first feature of interest. For example, if user 102 interacts with virtual warehouse 112 such that method 200 determines that the feature of interest is a sunroof and the first search results indicate a number of vehicles with sunroofs in the dealer's stock, virtual warehouse 112 may be modified such that the vehicles with sunroofs and/or a greater number of vehicles with sunroofs are configured to be displayed.

In some instances, one or more features of interest may be determined that are not available in a dealer's stock. For example, if a first feature of interest is motorcycle and a dealer does not have any motorcycles in stock, method 200 may determine that one or more objects with the first features of interest may be available in a different dealer's stock. The virtual warehouse may be modified based on the other dealer's stock, e.g., to display the available one or more objects, to indicate that the object is available from a different dealer, location, etc.

In some embodiments, modifying the virtual warehouse may include identifying at least one object in the virtual warehouse exhibiting a feature that is at least one counterexample of the determined first feature of interest. At least one counterexample may be determined to gauge the correctness of the determined feature of interest. The at least one counterexample may be based on the first feature of interest. For example, if the first feature of interest is sedans, a counterexample may be an SUV, a motorcycle, etc. In some embodiments, the user's interest in the at least one counterexample to the first feature of interest may be determined. The user's interest in the at least one counterexample may be determined based on one or more of a further user gaze fixation time, a further user gaze fixation value, a further user proximity time, a further user proximity value, a further user interaction time, or a further user interaction value. If method 200 determines that the user is uninterested in the counterexample to a threshold value, the counterexample may be removed from the virtual warehouse, a different counterexample may be added to the virtual warehouse, the feature of interest may be confirmed, etc. If method 200 determines that the user is interested in the counterexample to a threshold value, the virtual warehouse may be modified based on the counterexample.

In some embodiments, e.g., in embodiments where a counterexample to the determined feature of interest is not present in the virtual warehouse, modifying the virtual warehouse may include modifying an inventory of the virtual warehouse to include the at least one counterexample to the determined first feature of interest to use as a control feature of interest. For example, if a first feature of interest is motorcycles, the inventory may include predominantly motorcycles. In this example, the virtual warehouse may be modified to add a counterexample, e.g., an SUV, a sedan, etc., to the inventory.

At step 210, the system hosting the VR system may cause the modified virtual warehouse to be outputted. The modified virtual warehouse may be outputted via a GUI, e.g., a GUI associated with user device 107. In some techniques, the modified virtual warehouse may be outputted out of the sight of user 102. For example, the modified virtual warehouse may be outputted when avatar 113 is in a different virtual warehouse 112, when user 102 is not looking at the modified virtual warehouse and/or the at least one virtual object 114 within the modified virtual warehouse, etc. In other words, the modified virtual warehouse may be outputted in such a way that user 102 is not aware of the change.

As discussed herein, more than one feature of interest may be determined. FIG. 2B depicts an exemplary method for determining a second feature of interest and modifying the virtual warehouse based on the first feature of interest and/or the second feature of interest. At step 252, a second feature of interest of a virtual object of a virtual warehouse may be determined. The second feature of interest may be determined using any suitable data, e.g., feature of interest data. For example, avatar 113 in virtual warehouse 112 may stand near an SUV for a longer amount of time than a sedan, which may indicate that SUV is a first feature of interest associated with user 102 and method 200 may modify the virtual warehouse to reflect this indication. If avatar 113 then interacts with two-door SUVs for a longer amount of time than a four-door SUV, having two doors may be a second feature of interest associated with user 102.

At step 254, a search query may be generated, e.g., a second search query. The second search query may be generated based on one or more features of interest or a combination of features of interest. For example, a first search query may be generated based on a first feature of interest, e.g., SUVs, a second search query may be generated based on the first feature of interest and a second feature of interest, e.g., two-door SUVs, a third search query may be generated based on the first feature of interest, the second feature of interest, and a third feature of interest, e.g., red two-door SUVs, etc.

In this example, the search queries subsequent to the first search query may be based on the search results of the previous one or more search queries. In another example, a first search query may be generated based on a first feature of interest, e.g., SUVs, and a second search query may be generated based on a counterexample, e.g., motorcycles. In this example, the second search query may incorporate some aspects of the search results of the first search query, or the second search query may be independent of the search results of the first search query. Search queries subsequent to the first search query may be based on, e.g., search within, the search results of the first search query. For instance, searching for two door vehicles within the results of SUVs may result in second results of two-door SUVs. Subsequent searches being searches within prior search results may reduce the search bounds for the subsequent searches, and thus improve efficiency and/or reduce complexity. In another example, multiple features of interest may be combined within a single search query, e.g., a full database may be searched for red two-door SUVs.

In some embodiments, the second search query may be generated by determining weights for each of the determined first feature of interest and the second feature of interest. As such, the second search query may be generated based on the determined first feature of interest, the determined second feature of interest, and the determined weights. For example, if a second feature of interest, e.g., being door-less, is weighted more than a first feature of interest, e.g., SUV, the second search query may be generated based on SUVs with or without doors.

At step 256, one or more second search results corresponding to the second search query may be identified. The one or more second search results may include one or more objects determined based on the first feature of interest and/or the second feature of interest. For example, a second search query may show one or more search results for SUVs (determined first feature of interest) with two doors (determined second feature of interest) in a given vehicle dealer's stock. In some embodiments, each object of the one or more objects may include one or more features. As discussed herein, in some embodiments, the one or more features for vehicles may be one or more of style, make, model, year, mileage, miles per gallon, battery power, color, number of doors, presence of a sunroof or moon roof, tire size, number of tires, design, etc. For example, if the second search query is based on having three tires as the first feature of interest and the color red as the second feature of interest, the one or more second search results may include three-wheeled modes of transportation in the color red that are available in a dealer's stock.

At step 258, the virtual warehouse may be modified. In some embodiments, the virtual warehouse may be modified based on the second search results. In some embodiments, the inventory of the virtual warehouse, e.g., one or more virtual objects, may be modified to include a higher proportion of objects having the determined first feature of interest and/or the determined second feature of interest. For example, if user 102 interacts with virtual warehouse 112 such that methods 200 and 250 determine that the first feature of interest is sedan and the second feature of interest is a sunroof, respectively, and the second search results indicate a number of sedans with sunroofs in the dealer's stock, virtual warehouse 112 may be modified such that the sedans with sunroofs and/or a greater number of sedans with sunroofs are configured to be displayed.

In some instances, one or more features of interest may be determined that are not available in a dealer's stock. For example, if a first feature of interest is SUV and a second feature of interest is a sunroof and a dealer does not have any SUVs with sunroofs in stock, method 250 may determine that such a combination of features of interest may be available in a different dealer's stock. The virtual warehouse may be modified based on the other dealer's stock, e.g., to display the available object, to indicate that the object is available from a different dealer, location, etc.

In some embodiments, modifying the virtual warehouse may include identifying at least one object in the virtual warehouse exhibiting a feature that is at least one counterexample of the determined second feature of interest. The at least one counterexample may be based on one or more features of interest. For example, if a first feature of interest is sedans and a second feature of interest is having four doors, a counterexample may be a four-door SUV, a two-door SUV, and/or a two-door sedan. In some embodiments, the user's interest in the at least one counterexample to a feature of interest may be determined. The user's interest in the at least one counterexample may be determined based on one or more of a further user gaze fixation time, a further user gaze fixation value, a further user proximity time, a further user proximity value, a further user interaction time, or a further user interaction value.

In some embodiments, modifying the virtual warehouse may include modifying an inventory of the virtual warehouse to include the at least one counterexample to at least the determined second feature of interest to use as a control feature of interest. For example, if a first feature of interest is sedans and a second feature of interest is having four doors, the inventory may include four-door sedans. In this example, the virtual warehouse may be modified to add a counterexample, e.g., a four-door SUV, a two-door SUV, and/or a two-door sedan, to the inventory.

At step 260, the system hosting the VR system may cause the modified virtual warehouse to be outputted. The modified virtual warehouse may be outputted via a GUI, e.g., a GUI associated with user device 107, and/or via any of the methods described herein, e.g., the method described in step 210.

In some embodiments, one or more of steps 202-212 and/or steps 252-260 may be repeated. Repeating one or more of these steps may increase the accuracy and/or reliability of the determination of the one or more features of interest for a given user.

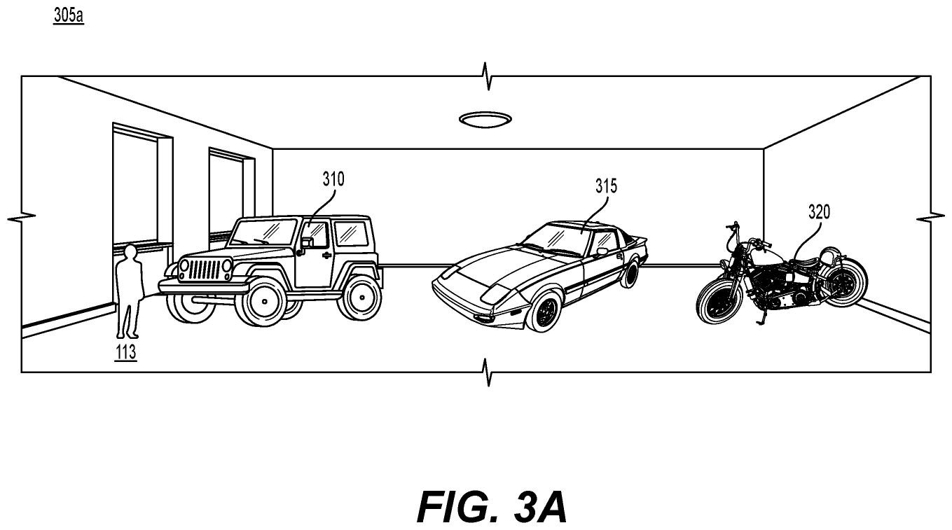

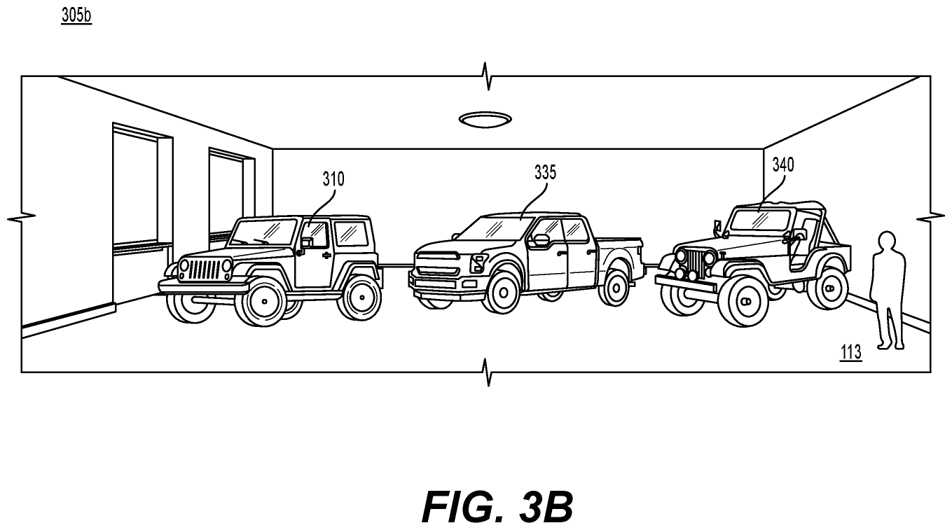

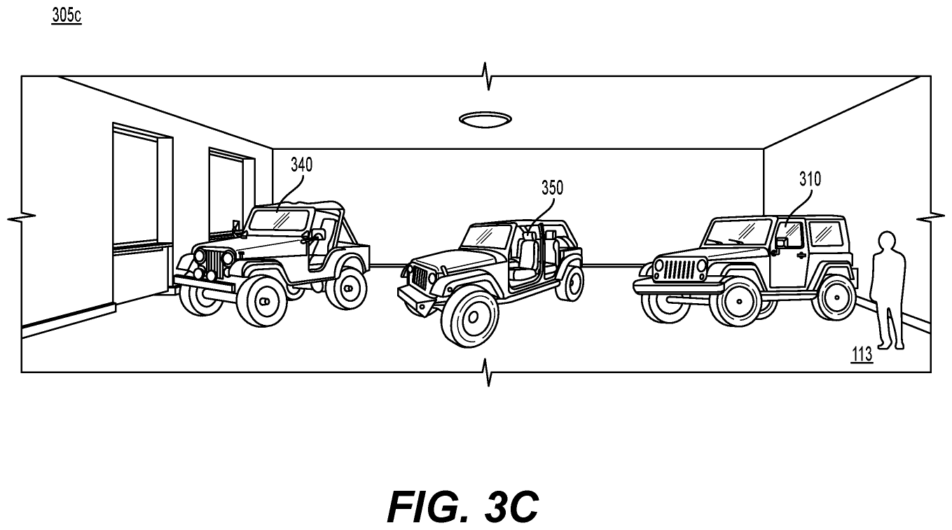

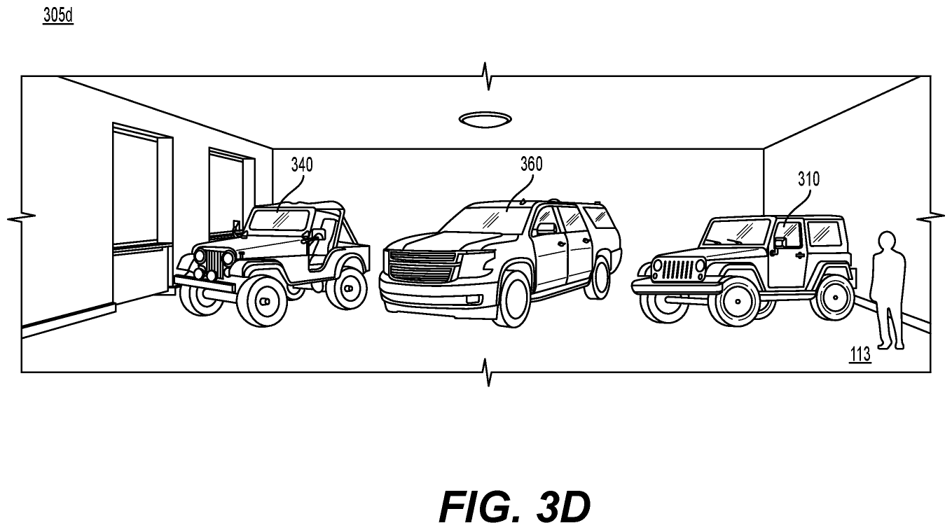

FIGS. 3A-3D depict exemplary visual representations of interactions of a user 102 with a virtual warehouse 305a-d, such as according to one or more aspects of method 200 and/or method 250. FIG. 3A depicts a first virtual warehouse 305a. First virtual warehouse 305a may include an inventory of one or more virtual objects, e.g., a first SUV 310, a first sedan 315, a first motorcycle 320, etc. Avatar 113 may stand or move near first SUV 310 and/or look at first SUV 310 a greater amount than avatar 113 stands near, moves near, and/or looks at first sedan 315 and/or first motorcycle 320. Based on at least this interaction data, method 200 may determine that a first feature of interest may be SUVs.

FIG. 3B depicts a second virtual warehouse 305b. Second virtual warehouse 305b may be a modified virtual warehouse generated based on the first feature of interest determined from FIG. 3A, e.g., SUVs. As described herein, method 200 may modify the inventory of first virtual warehouse 305a to include a higher proportion of objects having the determined first feature of interest, e.g., SUVs. As depicted in FIG. 3B, the second virtual warehouse 305b may include an inventory with a higher proportion of SUVs, e.g., first SUV 310, a second SUV 335, a third SUV 340, etc.

In some embodiments, more than one feature of interest may be determined. For example, as discussed herein, a second feature of interest may be determined. Avatar 113, as depicted in FIG. 3B, may stand or move near third SUV 340 and/or look at third SUV 340 a greater amount than avatar 113 stands near, moves near, and/or looks at first SUV 310 and/or second SUV 335. Based at least on this interaction data, method 200 may determine that a second feature of interest may be having no doors.

As described herein, e.g., in method 250, a further modified virtual warehouse may be generated based on second search results for the first feature of interest and/or the second feature of interest. FIG. 3C depicts a third virtual warehouse 305c that may be modified and/or generated based on at least, for example, the second search results for door-less SUVs. Modified virtual warehouse 305c depicts third SUV 340 and fourth SUV 350 as exemplary results of the second search results for door-less SUVs.

In some embodiments, a counterexample may be presented in the inventory. The counterexample may be based on a previous search result (e.g., previously displayed in the virtual warehouse) or a new search result (e.g., has not been previously displayed in the virtual warehouse). For example, as depicted in FIG. 3C, first SUV 310—which may include doors may be presented in the inventory as a counterexample to the door-less SUVs. If avatar 113 interacts with first SUV more than other objects in virtual warehouse 305c, one or more of the methods described herein may determine that having doors is a more heavily weighted feature of interest than not having doors. As such, a higher proportion of doored SUVs may be added to the inventory.

As depicted in virtual warehouse 305d of FIG. 3D, using methods described herein, one or more search results for the feature of interest for the counterexample, e.g., having doors, may be displayed in a higher proportion. Virtual warehouse 305d may include third SUV 340, first SUV 310, and/or fifth SUV 360. Fifth SUV 360 may act as a further counterexample to continue honing in on a user's desired vehicle. Use of one or more counterexamples may enable the systems and methods described herein to update for a user's changing opinion, to more accurately determine a user's desired vehicle based on passive interaction, and/or to reduce the impact of false positives. For example, avatar 113 may unintentionally passively interact with a vehicle due to user 102 not paying attention while directing avatar 113, a system glitch (e.g., the application malfunctioning), etc.

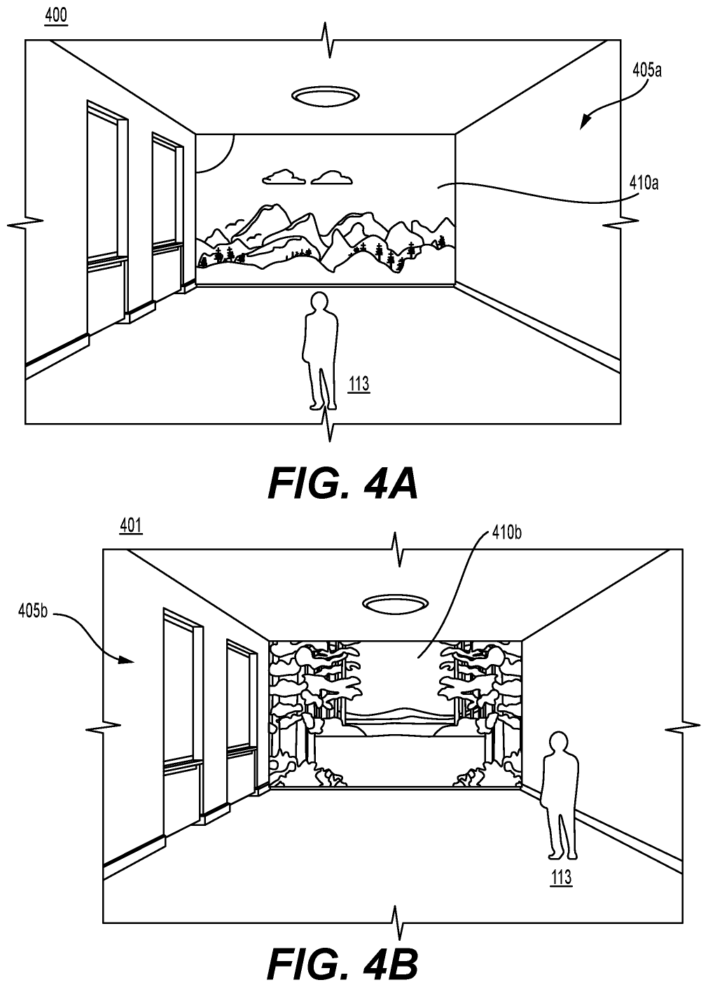

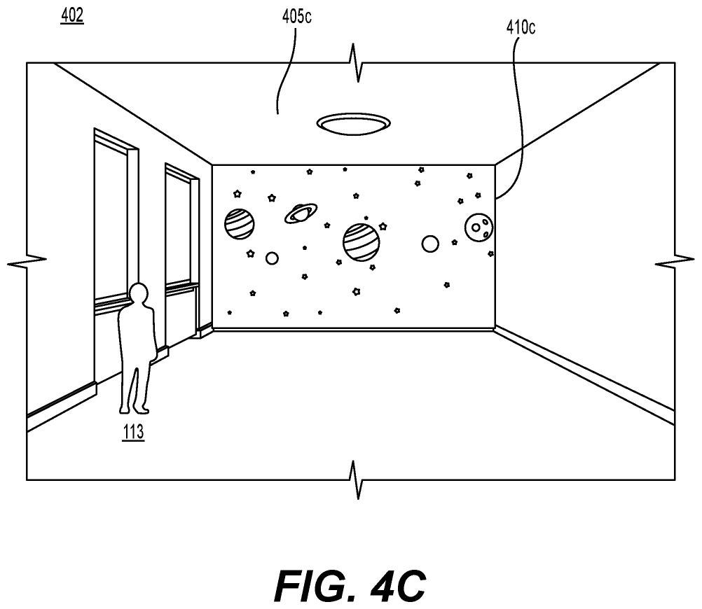

In some techniques, other aspects of a virtual space, e.g., the environment of virtual warehouse 112, may be modified. Aspects of the environment may be modified, e.g., based on passive feedback, machine learning, etc., to elicit a response from user 102. For example, if avatar 113 enters a first environment and increased eye movements are detected via user device 107, the first environment may be determined to elicit a response from user 102. In another example, if avatar 113 enters a second environment and decreased eye movements are detected via user device 107, the second environment may be determined to not elicit a response from user 102. The schematics described below (FIGS. 4A-4C) depict exemplary modifications of the environment of virtual warehouse 112.

FIGS. 4A-4C depict further exemplary visual representations of various aspects of this disclosure. Environment 400 of FIG. 4A depicts a first virtual warehouse 405a, Environment 401 of FIG. 4B depicts a second virtual warehouse 405b, and Environment 402 of FIG. 4C depicts a third virtual warehouse 405c. In some embodiments each of first virtual warehouse 405a, second virtual warehouse 405b, and third virtual warehouse 405c may be virtual rooms within a larger virtual warehouse. For example, first virtual warehouse 405a may include a first virtual room, e.g., mountain background 410a. Second virtual warehouse 405b may include a second virtual room, e.g., forest background 410b. Third virtual warehouse 405c may include a third virtual room, e.g., a space background 410c.

In some embodiments, avatar 113 may move from various parts of a virtual warehouse to be in front of a different background. For example, each of mountain background 410a, forest background 410b, and/or space background 410c may be in virtual rooms of a virtual warehouse, e.g., virtual warehouse 112. If avatar 113 spends more time in the virtual room with forest background 410b, forest background 410b may be determined to be a feature of interest. As such, a higher proportion of virtual rooms may display one or more variations of a forest background.

As described herein, a counterexample background may be presented to gauge the correctness of a background. Continuing the prior example, a virtual room may display space background 410c as a counterexample to forest background 410b. If avatar 113 continues to interact relatively more with forest background 410b, the counterexample may be rejected. If avatar 113 interacts relatively more with space background 410c, the counterexample may be presented in a greater proportion relative to the forest background.

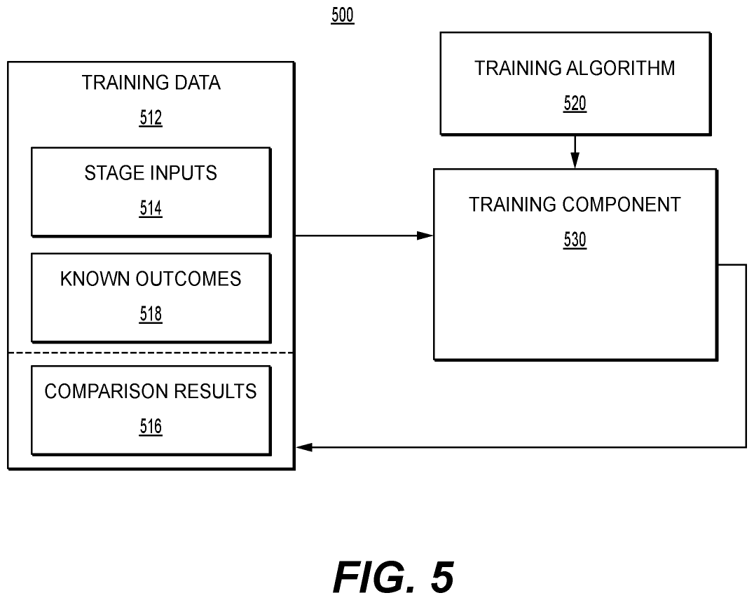

One or more implementations disclosed herein include and/or are implemented using a machine learning model, e.g., one or more of the systems of virtual warehouse system 115 are implemented using a machine learning model and/or are used to train the machine learning model. A given machine learning model is trained using the training flow chart 500 of FIG. 5. The training data 512 includes one or more of stage inputs 514 and the known outcomes 518 related to the machine learning model to be trained. The stage inputs 514 are from any applicable source including text, visual representations, data, values, comparisons, and stage outputs, e.g., one or more outputs from one or more steps from FIGS. 2A-2B. The known outcomes 518 are included for the machine learning models generated based on supervised or semi-supervised training. An unsupervised machine learning model is not trained using the known outcomes 518. The known outcomes 518 includes known or desired outputs for future inputs similar to or in the same category as the stage inputs 514 that do not have corresponding known outputs.

The training data 512 and a training algorithm 520, e.g., one or more of the modules implemented using the machine learning model and/or are used to train the machine learning model, is provided to a training component 530 that applies the training data 512 to the training algorithm 520 to generate the machine learning model. According to an implementation, the training component 530 is provided comparison results 516 that compare a previous output of the corresponding machine learning model to apply the previous result to re-train the machine learning model. The comparison results 516 are used by the training component 530 to update the corresponding machine learning model. The training algorithm 520 utilizes machine learning networks and/or models including, but not limited to a deep learning network such as a transformer, Deep Neural Networks (DNN), Convolutional Neural Networks (CNN), Fully Convolutional Networks (FCN) and Recurrent Neural Networks (RCN), probabilistic models such as Bayesian Networks and Graphical Models, classifiers such as K-Nearest Neighbors, and/or discriminative models such as Decision Forests and maximum margin methods, the model specifically discussed herein, or the like.

The machine learning model used herein is trained and/or used by adjusting one or more weights and/or one or more layers of the machine learning model. For example, during training, a given weight is adjusted (e.g., increased, decreased, removed) based on training data or input data. Similarly, a layer is updated, added, or removed based on training data/and or input data. The resulting outputs are adjusted based on the adjusted weights and/or layers.

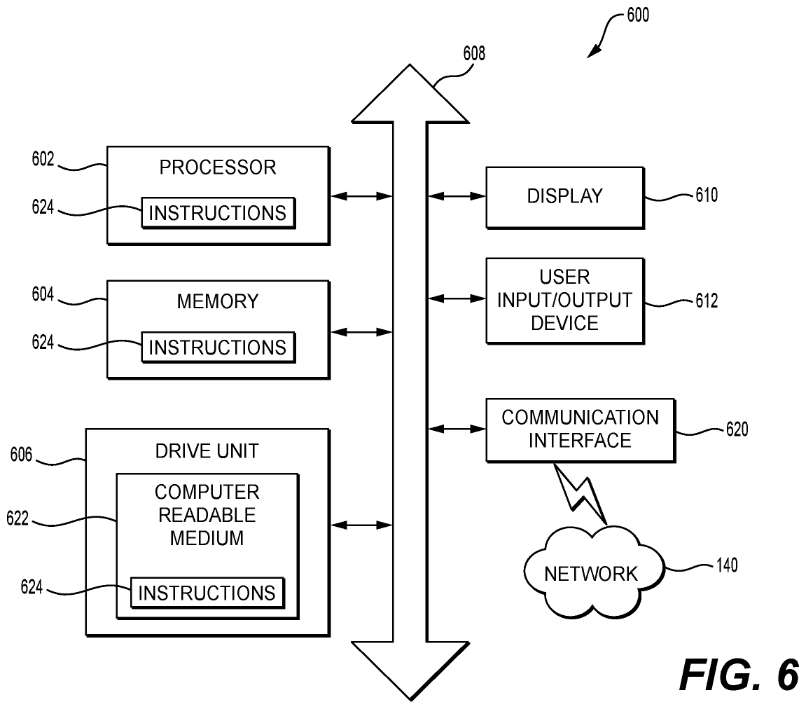

FIG. 6 depicts a simplified functional block diagram of a computer 600 that may be configured as a device for executing the methods disclosed here, according to exemplary embodiments of the present disclosure. For example, the computer 600 may be configured as a system according to exemplary embodiments of this disclosure. In various embodiments, any of the systems herein may be a computer 600 including, for example, a data communication interface 620 for packet data communication. The computer 600 also may include a central processing unit (CPU) 602, in the form of one or more processors, for executing program instructions. The computer 600 may include an internal communication bus 608, and a storage unit 606 (such as ROM, HDD, SDD, etc.) that may store data on a computer readable medium 622, although the computer 600 may receive programming and data via network communications. The computer 600 may also have a memory 604 (such as RAM) storing instructions 624 for executing techniques presented herein, although the instructions 624 may be stored temporarily or permanently within other modules of computer 600 (e.g., processor 602 and/or computer readable medium 622). The computer 600 also may include input and output ports 612 and/or a display 610 to connect with input and output devices such as keyboards, mice, touchscreens, monitors, displays, etc. The various system functions may be implemented in a distributed fashion on a number of similar platforms, to distribute the processing load. Alternatively, the systems may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A method for dynamically modifying a virtual warehouse, the method comprising:
determining a first feature of interest of a virtual object of the virtual warehouse based on a first passive user interaction with the virtual object;
generating a first search query based on the determined first feature of interest;
identifying one or more first search results that corresponds to the first search query, the one or more first search results including at least one object with at least one feature;
modifying the virtual warehouse based on the one or more first search results; and
causing a user interface to output the modified virtual warehouse.

2. The method of claim 1, wherein the first passive user interaction includes one or more of a user gaze fixation time, a user gaze fixation value, a user proximity time, a user proximity value, a user interaction time, or a user interaction value.

3. The method of claim 2, wherein the determining the first feature of interest of a virtual object of the virtual warehouse further comprises:
determining that the one or more of the user gaze fixation time, the user gaze fixation value, the user proximity time, the user proximity value, the user interaction time, or the user interaction value are above a predetermined threshold.

4. The method of claim 1, wherein the modifying the virtual warehouse based on the one or more first search results includes modifying an inventory of the virtual warehouse to include a higher proportion of objects having the determined first feature of interest.

5. The method of claim 1, wherein the modifying the virtual warehouse based on the one or more first search results includes either (i) identifying at least one object in the virtual warehouse exhibiting a feature that is at least one counterexample of the determined first feature of interest, or (ii) modifying an inventory of the virtual warehouse to include the at least one counterexample to the determined first feature of interest to use as a control feature of interest.

6. The method of claim 5, further comprising:
determining a user's interest in the at least one counterexample to gauge a correctness of the determined first feature of interest,
wherein the user's interest is determined based on one or more of a further user gaze fixation time, a further user gaze fixation value, a further user proximity time, a further user proximity value, a further user interaction time, or a further user interaction value.

7. The method of claim 1, further comprising:
determining a second feature of interest of the virtual object of the virtual warehouse based on a second passive user interaction with the virtual object;
generating a second search query based on the determined first feature of interest and the determined second feature of interest;
identifying one or more second search results that corresponds to the second search query, the one or more second search results including a portion of the at least one object with at least one feature, the portion of the at least one object with at least one feature including the determined first feature of interest and the determined second feature of interest;
modifying the virtual warehouse based on the one or more second search results; and
causing the user interface to output the modified virtual warehouse.

8. The method of claim 7, wherein the modifying the virtual warehouse based on the one or more second search results includes modifying the at least one object with at least one feature such that a higher proportion of the at least one object with at least one feature includes the determined first feature of interest and the determined second feature of interest.

9. The method of claim 7, wherein the generating of the second search query further comprises:
determining weights for each of the determined first feature of interest and the second feature of interest; and
generating the second search query based on the determined first feature of interest, the determined second feature of interest, and the determined weights.

10. The method of claim 1, wherein the determining of the first feature of interest includes:
obtaining passive user interaction data that includes the first passive user interaction with the virtual object; and
determining, via a trained machine learning model, one or more user preferences based on the passive user interaction data;
wherein the trained machine learning model has been trained based on training passive user interaction data, training feature of interest data, training virtual object data, and training virtual warehouse data, to learn associations between the training passive user interaction data and the training feature of interest data, such that the trained machine learning model is configured to output the first feature of interest in response to input of the passive user interaction data.

11. A system, the system comprising:
at least one memory storing instructions; and
at least one processor executing the instructions to perform operations for dynamically modifying a virtual warehouse, the operations including:
determining a first feature of interest of a virtual object of the virtual warehouse based on a first passive user interaction with the virtual object;
generating a first search query based on the determined first feature of interest;
identifying one or more first search results that corresponds to the first search query, the one or more first search results including at least one object with at least one feature;
modifying the virtual warehouse based on the one or more first search results; and
causing a user interface to output the modified virtual warehouse.

12. The system of claim 11, wherein the first passive user interaction includes one or more of a user gaze fixation time, a user gaze fixation value, a user proximity time, a user proximity value, a user interaction time, or a user interaction value.

13. The system of claim 12, wherein the determining the first feature of interest of a virtual object of the virtual warehouse further comprises:
determining that the one or more of the user gaze fixation time, the user gaze fixation value, the user proximity time, the user proximity value, the user interaction time, or the user interaction value are above a predetermined threshold.

14. The system of claim 11, wherein the modifying the virtual warehouse based on the one or more first search results includes modifying an inventory of the virtual warehouse to include a higher proportion of objects having the determined first feature of interest.

15. The system of claim 11, wherein the modifying the virtual warehouse based on the one or more first search results includes either (i) identifying at least one object in the virtual warehouse exhibiting a feature that is at least one counterexample of the determined first feature of interest, or (ii) modifying an inventory of the virtual warehouse to include the at least one counterexample to the determined first feature of interest to use as a control feature of interest.

16. The system of claim 11, further comprising:
determining a second feature of interest of the virtual object of the virtual warehouse based on a second passive user interaction with the virtual object;
generating a second search query based on the determined first feature of interest and the determined second feature of interest;
identifying one or more second search results that corresponds to the second search query, the one or more second search results including a portion of the at least one object with at least one feature, the portion of the at least one object with at least one feature including the determined first feature of interest and the determined second feature of interest;
modifying the virtual warehouse based on the one or more second search results; and
causing the user interface to output the modified virtual warehouse.

17. The system of claim 16, wherein the modifying of the virtual warehouse based on the one or more second search results includes modifying the at least one object with at least one feature such that a higher proportion of the at least one object with at least one feature includes the determined first feature of interest and the determined second feature of interest.

18. The system of claim 16, wherein the generating of the second search query further comprises:
determining weights for each of the determined first feature of interest and the second feature of interest; and
generating the second search query based on the determined first feature of interest, the determined second feature of interest, and the determined weights.

19. The system of claim 11, wherein the determining of the first feature of interest includes:
obtaining passive user interaction data that includes the first passive user interaction with the virtual object; and
determining, via a trained machine learning model, one or more user preferences based on the passive user interaction data;
wherein the trained machine learning model has been trained based on training passive user interaction data, training feature of interest data, training virtual object data, and training virtual warehouse data, to learn associations between the training passive user interaction data and the training feature of interest data, such that the trained machine learning model is configured to output the first feature of interest in response to input of the passive user interaction data.

20. A method for dynamically modifying a virtual warehouse, the method comprising:
determining a first feature of interest of a virtual object of the virtual warehouse by:
determining a potential interest in a feature based on a first passive user interaction with the feature, the first passive user interaction including one or more of a user gaze fixation time, a user gaze fixation value, a user proximity time, a user proximity value, a user interaction time, or a user interaction value;
gauging a correctness of the potential interest in the feature of interest by:
determining, to use as a control feature, a potential interest in a counterexample feature of the feature, based on a second passive user interaction with the counterexample feature, the second passive user interaction including one or more of a further user gaze fixation time, a further user gaze fixation value, a further user proximity time, a further user proximity value, a further user interaction time, or a further user interaction value; and
comparing the potential interest in the feature with the potential interest in the counterexample feature;
generating a first search query based on the determined first feature of interest;
identifying one or more first search results that corresponds to the first search query, the one or more first search results including at least one object with at least one feature;
modifying the virtual warehouse based on the one or more first search results; and
causing a user interface to output the modified virtual warehouse.
